(19) United States
(12) Patent Application Publication
(10) Pub. No.: US 2008/0320421 A1
(43) Pub. Date: Dec. 25, 2008

(54) FEATURE EXTRACTION THAT SUPPORTS PROGRESSIVELY REFINED SEARCH AND CLASSIFICATION OF PATTERNS IN A SEMICONDUCTOR LAYOUT

(76) Inventors: David L. Demaris, Austin, TX (US); Rouwaida N. Kanj, Round Rock, TX (US); Daniel N. Maynard, Cragsbury Common, VT (US); Michael D. Monkowski, New Windsor, NY (US)

Correspondence Address: HOFFMAN WARNICK LLC, 75 STATE ST, 14TH FLOOR, ALBANY, NY, 12207, US

(21) Appl. No.: 11/765,473

(22) Filed: Jun. 20, 2007

(51) Int. Cl. G06F 17/50

(52) U.S. Cl. 716/4

(57) ABSTRACT

A system, method and program product for searching and classifying patterns in a VLSI design layout. A method is provided that includes generating a target vector using a two dimensional (2D) low discrepancy sequence; identifying layout regions in a design layout; generating a feature vector for a layout region; comparing a subset of sequence values in the target vector with sequence values in the feature vector as an initial filter, wherein the system for comparing determines that the layout region does not contain a match if a comparison of the subset of sequence values in the target vector with sequence values in the feature vector falls below a threshold; and outputting search results.

### BACKGROUND

1. Technical Field

The disclosure relates generally to pattern searching and more particularly to a system and method of performing progressively refined pattern searching and classification that compares vector data collected from a target region with vector data obtained from layout design data.

2. Background Art

Due to increasing complexity of lithography, etch, polish and other semiconductor processes, semiconductor manufacturers face a growing challenge in which certain local patterns on one or more design levels present manufacturing difficulties, including fails, electrical (parametric) yield problems, or a small dose-focus process window.

In addition, elaborate software based resolution enhancement techniques are deployed to improve imaging fidelity on the wafer. New types of design for manufacturing (DFM) software are under development. Testing this software efficiently requires the characterization and classification of typical local layout patterns. Many designs for manufacturing tools require models to be developed that are calibrated and parameterized via hardware test site calibration. Scanning and classification of designs can improve the development of models by assessing coverage of test site structures on realistic layout patterns. Such classification may use statistical methods such as data clustering, which requires the data to be translated into the form of numerical vectors.

In recent years, several software based systems have been introduced that support search functions (i.e., the retrieval of patterns similar to a target layout clip) and the classification of layout patterns. Because the volume of data is very great, the computing cost of implementing such search functions is significant. However, the ability to produce high quality matches is important. Accordingly, a need exists for efficient techniques that can identify pattern matches in a VLSI layout.

### SUMMARY

A system and method of analyzing shapes to search for patterns in a VLSI layout are disclosed. The system and method allow for the conversion of a layout on several layers to a vector of features, which can be compared to other layouts through standard distance functions. A multi-step process involving partial matching is utilized to reduce computational overhead. The resulting analysis can be used for any purpose, such as causal analysis of systematic defects, the generation of small test cases for optical proximity correction software, etc. Clustering operations may also be utilized to allow, e.g., categories of layout to be discovered through unsupervised learning and passed on to a variety of applications in test, design and analysis.

In one aspect of the invention, low discrepancy sequences, sometimes known as quasi-random sequences, are utilized to determine anchor points for the description of shapes. Such sequences were originally developed to promote the rapid convergence of numerical integrals in a high dimension. In contrast to pseudo-random sequences, each value in the low discrepancy sequence is highly correlated with the previous sequence, and approximately maximizes the distance between subsequent points. These low discrepancy sequences share the property that for all N, the subsequence x₁, . . . , x_{N} is almost uniformly distributed as is x₁, . . . , x_{N+1}.

One advantage of this method compared to others is that low discrepancy sequences progressively fill space. This allows partial matching or screening to occur with only a few point evaluations, with candidates that pass the initial screen passed on for computation of features at a more detailed level of space filling (and corresponding additional features at higher spatial resolution). Partial matching at lower resolution may also provide some translation invariance, particularly with appropriate weighting on features during distance computations.

A first aspect of the disclosure provides a method of identifying patterns in a semiconductor layout, the method comprising: specifying a target region by indicating polygonal regions on a mask layer; generating a target vector using a two dimensional (2D) low discrepancy sequence; identifying layout regions in a design layout; generating a feature vector for a layout region; comparing a subset of sequence derived feature values in the target vector with sequence derived feature values in a search region feature vector as an initial filter; determining that the layout region does not contain a match if a comparison of the subset of sequence derived feature values in the target vector with corresponding values in the search region feature vector falls below a threshold; and outputting search results.

A second aspect of the disclosure provides a system for identifying patterns in a semiconductor layout, comprising: a system for generating a target vector using a two dimensional (2D) low discrepancy sequence to select anchor points for measuring features in a design layout; a system for identifying layout regions in the design layout; a system for generating a feature vector for a layout region; a system for comparing a subset of sequence derived feature values in the target vector with sequence derived values in a search region feature vector as an initial filter, wherein the system for comparing determines that the layout region does not contain a match if a comparison of the subset of sequence derived feature values in the target vector with sequence derived values in the feature vector falls below a threshold; and a system for outputting search results.

A third aspect of the disclosure provides a computer program product stored on a computer readable medium for identifying patterns in a semiconductor layout, which when executed causes a computer system to perform functions comprising: generating a target vector using a two dimensional (2D) low discrepancy sequence; identifying layout regions in a design layout; generating a feature vector for a layout region; comparing a subset of sequence derived feature values in the target vector with sequence derived feature values in a search region vector as an initial filter, wherein the comparing determines that the layout region does not contain a match if a comparison of the subset of sequence derived feature values in the target vector with corresponding sequence derived feature values in the search region vector falls below a threshold; and outputting search results.

The illustrative aspects of the present disclosure are designed to solve the problems herein described and/or other problems not discussed.

### BRIEF DESCRIPTION OF THE DRAWINGS

These and other features of this disclosure will be more readily understood from the following detailed description of the various aspects of the disclosure taken in conjunction with the accompanying drawings that depict various embodiments of the disclosure, in which:

FIG. 1 shows a computer system have a search system in accordance with an embodiment of the disclosure.

FIG. 2 shows an illustrative target region and associated sequence points in accordance with embodiments of the disclosure.

FIG. 3 shows an illustrative approach for calculating a vector from a target region in accordance with an embodiment of the disclosure.

It is noted that the drawings of the disclosure are not to scale. The drawings are intended to depict only typical aspects of the disclosure, and therefore should not be considered as limiting the scope of the disclosure. In the drawings, like numbering represents like elements between the drawings.

### DETAILED DESCRIPTION

As indicated above, the disclosure provides a system, method and program product for performing progressively refined pattern searching that compares vector data collected from a target region with vector data obtained from layout design data. In particular, partial matching is used initially to filter out design patterns that do not match a target pattern. For the purposes of this disclosure, the term “searching” should be interpreted broadly to include, e.g., matching, classifying, grouping, etc.

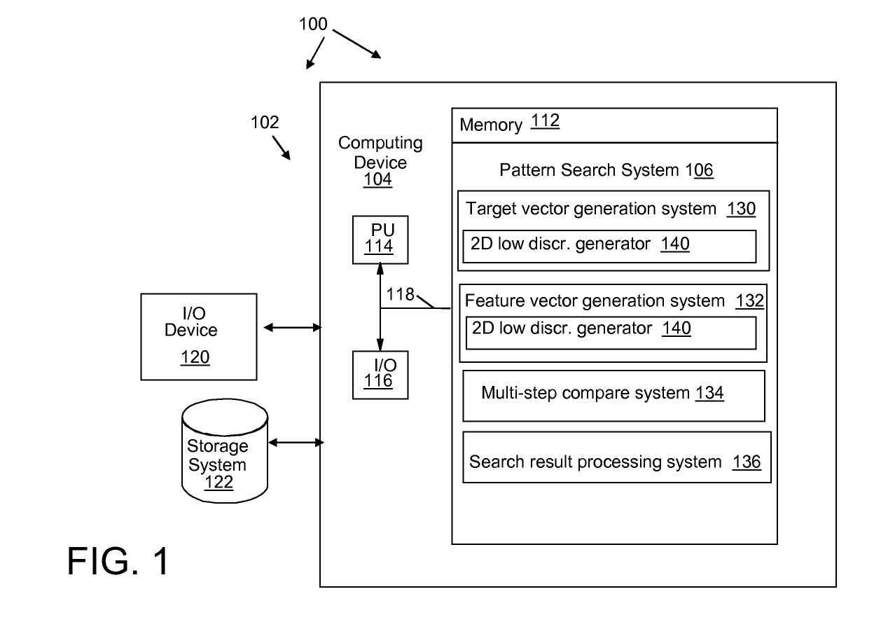

Turning to the drawings, FIG. 1 shows an illustrative environment 100 for performing pattern searching. To this extent, environment 100 includes a computer infrastructure 102 that can perform the various process steps described herein for performing pattern matching. In particular, computer infrastructure 102 is shown including a computing device 104 that comprises a pattern search system 106, which enables computing device 104 to identify patterns in a VLSI layout by performing the process steps of the disclosure.

Computing device 104 is shown including a memory 112, a processor (PU) 114, an input/output (I/O) interface 116, and a bus 118. Further, computing device 104 is shown in communication with an external I/O device/resource 120 and a storage system 122. As is known in the art, in general, processor 114 executes computer program code, such as pattern search system 106, that is stored in memory 112 and/or storage system 122. While executing computer program code, processor 114 can read and/or write data, such as layout design data, to/from memory 112, storage system 122, and/or I/O interface 116. Bus 118 provides a communications link between each of the components in computing device 104. I/O device 118 can comprise any device that enables a user to interact with computing device 104 or any device that enables computing device 104 to communicate with one or more other computing devices. Input/output devices (including but not limited to keyboards, displays, pointing devices, etc.) can be coupled to the system either directly or through intervening I/O controllers.

In any event, computing device 104 can comprise any general purpose computing article of manufacture capable of executing computer program code installed by a user (e.g., a personal computer, server, handheld device, etc.). However, it is understood that computing device 104 and pattern search system 106 are only representative of various possible equivalent computing devices that may perform the various process steps of the disclosure. To this extent, in other embodiments, computing device 104 can comprise any specific purpose computing article of manufacture comprising hardware and/or computer program code for performing specific functions, any computing article of manufacture that comprises a combination of specific purpose and general purpose hardware/software, or the like. In each case, the program code and hardware can be created using standard programming and engineering techniques, respectively.

Similarly, computer infrastructure 102 is only illustrative of various types of computer infrastructures for implementing the disclosure. For example, in one embodiment, computer infrastructure 102 comprises two or more computing devices (e.g., a server cluster) that communicate over any type of wired and/or wireless communications link, such as a network, a shared memory, or the like, to perform the various process steps of the disclosure. When the communications link comprises a network, the network can comprise any combination of one or more types of networks (e.g., the Internet, a wide area network, a local area network, a virtual private network, etc.). Network adapters may also be coupled to the system to enable the data processing system to become coupled to other data processing systems or remote printers or storage devices through intervening private or public networks. Modems, cable modem and Ethernet cards are just a few of the currently available types of network adapters. Regardless, communications between the computing devices may utilize any combination of various types of transmission techniques.

As previously mentioned and discussed further below, pattern search system 106 enables computing infrastructure 102 to identify patterns in a design layout. To this extent, pattern search system 106 is shown including a target vector generation system 130, a feature vector generation system 132, a multi-step compare system 134, and a search result processing system 136. Operation of each of these systems is discussed further below. However, it is understood that some of the various systems shown in FIG. 1 can be implemented independently, combined, and/or stored in memory for one or more separate computing devices that are included in computer infrastructure 102. Further, it is understood that some of the systems and/or functionality may not be implemented, or additional systems and/or functionality may be included as part of environment 100.

As noted, the disclosure provides pattern searching by comparing target vector data collected from a target region with feature vector data obtained from layout design data. Both the target vector generation system 130 and the feature vector generation system 132 utilize a two dimensional (2D) low discrepancy generator 140 for generating vectors. In general, two dimensional (2D) low discrepancy generator 140 generates a set of sequence points within a region containing shapes. Feature values are then obtained as a distance from the sequence points to one or more points on the shapes in the region. A collection of the feature values for the region forms a vector.

Multi-step compare system 134 provides a mechanism through which a target vector can be compared to a region under search to determine how similar a layout region is to a target region. In order to reduce computational overhead, multi-step compare system 134 does an initial compare in which only some of the sequence values are considered. If the initial compare does not meet a threshold, then the layout region is discarded as not being a match. If the initial compare meets a threshold, then a further compare that considers more or all of the sequence values can be done. If the further compare, e.g., using all of the sequence values, meets the threshold, then a match is identified. For the purposes of this disclosure, the term “threshold” may refer to any value or set of values, Boolean, numeric or otherwise. Thus, a match may comprise a partial match, an exact match, etc.

Search result processing system 136 further analyzes and processes any matching layouts for the particular application. For example, matches can be ranked, clustered, stored, etc.

The target region is specified by indicating polygonal areas on one or more mask layers. The target region need not be identically sized on each layer. Polygons intruding into a target region are clipped to the region boundary for the purposes of certain feature boundaries. Shapes may be annotated with properties derived from connectivity analysis including other layers not included in the search layer set.

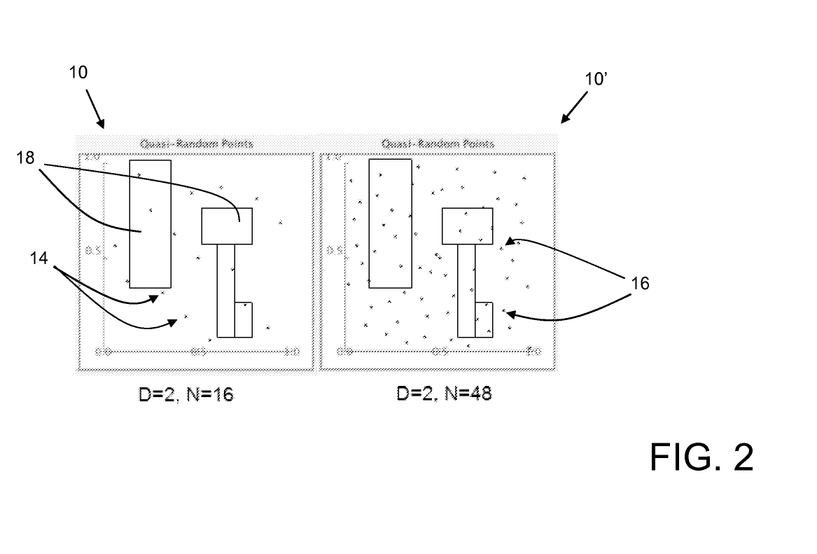

Once a target region is identified, a two-dimensional (2-D) low discrepancy sequence of some cardinality is generated in a unit square and coordinates are scaled to fit the regions. FIG. 2 depicts a target region 10 and 10′ containing a quasi-random two dimensional Sobol sequence generated with respect to polygons 18. On the left hand side, target region 10 is shown with sixteen sequence points 14. On the right hand side, target region 10′ is shown with 48 sequence points 16. More points in a sequence will give a feature descriptor with a higher information cost. Some experimental probing of random windows in the data may be performed to establish a knee in the sequence size beyond which additional points do not provide much more information. The number of sequence points generated need not be the same on every mask level; levels with more intricate patterns would typically use more sequence points, while restricted complexity levels would use fewer. Sequence coordinates are generated in the unit square as shown and scaled to fit the actual region of interest.

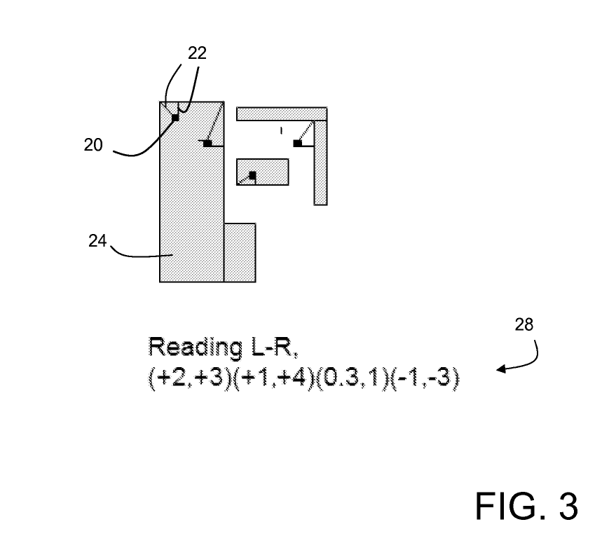

The points specified in the sequence are subjected to various distance tests against the nearest polygon data to create numerical sequence values. The sign of the value of each field indicates whether the sequence point is inside or outside the polygons in the region. The resulting vector is considered the target vector for matching purposes. FIG. 3 depicts an illustrative example containing four sequence points. As can be seen, sequence point 20 is associated with two distances 22 to two points (i.e., the nearest corner and edge) on polygon 24. A resulting target vector 28 for the four sequence points for the target region in FIG. 3 is shown as (+1,+3)(+1,+4)(0.3,1)(−1,−3).

The target vector 28 may be weighted based on user knowledge or hypothesis of the relative importance of the layers. Also, the target vector 28 may be weighted based on some probing of search design windows and evaluation of the density of points in the subspace of features corresponding to the target region. Very common patterns may be weighted lower, in order to emphasize the rare features.

The design layout to be searched, which may be stored, e.g., in storage system 122 of FIG. 1, is loaded into a searchable structure, possibly after overlapping regions are generated to support parallel searching on sub-regions of the design. The design layout under search is scanned for possible starting corner or center points for windows to be searched.

The low discrepancy sequence points used for the target region are applied to each window to be searched. If the window size is different from the target region, some scaling may be necessary. It is also possible to search with some scaling factor applied when, for example, the technique is used to search a design layout in technology node A for a pattern discovered in another technology node B. In this case, the design layout would be rescaled based on the relative size of a common dimension such as the minimum line width.

Feature vector values are then determined by computing distances from sequence points in the design layout to the scaled sequence points for the data under search. The following illustrative list of sequence values may be computed as features.
distance from sequence point to nearest corner on any polygon (sign conveys inside or outside polygon)
distance from sequence point to farthest corner on any polygon
angle to from sequence point to nearest corner on any polygon
distance from sequence point to nearest midpoint of any polygon edge
average distance from sequence point to all corner points on all polygons
average distance from sequence point to centroid of all polygon points
average distance from sequence point to centroid of nearest polygon
length of nearest polygon edge to sequence point (sign can convey direction of edge)
   Additional features may be computed independent of the sequence points, including
minimum width of a shape
minimum distance between shapes
maximum width of a shape
maximum distance between shapes
number of edges in window
number of points in window
average distance between all pairs of corner points

As noted, in order to provide a lower cost search, a subset of the sequence values used for the target region are first compared as an initial filter, prior to computation of the rest of the sequence-linked features.

This initial subset can eliminate significant computation. For example, if a 24 point sequence were used for each target region, the first 8 points might be used as a filter when searching. Search regions not meeting some distance threshold would be abandoned without computing features (i.e., distance values to additional 2D sequence points) for the additional 16 points.

For search applications, distance computations are performed and matches are collated by distance. Some banning may be done to show only a subset of the match points.

For classification applications, online clustering can be performed by comparing each prototype vector (e.g., a cluster center) with a comprehensive scan, and adjusting the cluster center to move in the direction of nearest points to the cluster. An application might choose to maintain copies or pointers to nearest and farthest representatives of each cluster.

Note that the present disclosure differs from image analysis in that the selected points are in geometric space and an arbitrary set of computations is performed on points; this is in contrast to the image analysis where points in a bitmap are subjected to pixel analysis based on the scaled sequence points.

Also note that the architecture for computing the points should exploit parallel processing. In MIMD architecture, region contents may be replicated to each processor's local memory along with code fragments to compute one or more subsets of the features. The features may then be joined to a composite vector by a copy operation into shared memory.

As discussed herein, various systems and components are described as obtaining and processing data (e.g., target vector generation system 130, etc.). It is understood that the corresponding data can be obtained using any solution. For example, the corresponding system/component can generate and/or be used to generate the data, retrieve the data from one or more data stores (e.g., a database), receive the data from another system/component, and/or the like. When the data is not generated by the particular system/component, it is understood that another system/component can be implemented apart from the system/component shown, which generates the data and provides it to the system/component and/or stores the data for access by the system/component.

While shown and described herein as a method and system for pattern searching, it is understood that the disclosure further provides various alternative embodiments. That is, the disclosure can take the form of an entirely hardware embodiment, an entirely software embodiment or an embodiment containing both hardware and software elements. In a preferred embodiment, the disclosure is implemented in software, which includes but is not limited to firmware, resident software, microcode, etc. In one embodiment, the disclosure can take the form of a computer program product accessible from a computer-usable or computer-readable medium providing program code for use by or in connection with a computer or any instruction execution system, which when executed, enables a computer infrastructure to perform pattern searching. For the purposes of this description, a computer-usable or computer readable medium can be any apparatus that can contain, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium. Examples of a computer-readable medium include a semiconductor or solid state memory, such as memory 112, magnetic tape, a removable computer diskette, a random access memory (RAM), a read-only memory (ROM), a tape, a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processing unit 114 coupled directly or indirectly to memory elements through a system bus 118. The memory elements can include local memory, e.g., memory 112, employed during actual execution of the program code, bulk storage (e.g., memory system 122), and cache memories which provide temporary storage of at least some program code in order to reduce the number of times code must be retrieved from bulk storage during execution.

In another embodiment, the disclosure provides a method of generating a system for pattern searching. In this case, a computer infrastructure, such as computer infrastructure 112 (FIG. 1), can be obtained (e.g., created, maintained, having made available to, etc.) and one or more systems for performing the process described herein can be obtained (e.g., created, purchased, used, modified, etc.) and deployed to the computer infrastructure. To this extent, the deployment of each system can comprise one or more of: (1) installing program code on a computing device, such as computing device 104 (FIG. 1), from a computer-readable medium; (2) adding one or more computing devices to the computer infrastructure; and (3) incorporating and/or modifying one or more existing systems of the computer infrastructure, to enable the computer infrastructure to perform the process steps of the disclosure.

In still another embodiment, the disclosure provides a business method that performs the process described herein on a subscription, advertising, and/or fee basis. That is, a service provider could offer to provide pattern searching as described herein. In this case, the service provider can manage (e.g., create, maintain, support, etc.) a computer infrastructure, such as computer infrastructure 102 (FIG. 1), that performs the process described herein for one or more customers. In return, the service provider can receive payment from the customer(s) under a subscription and/or fee agreement, receive payment from the sale of advertising to one or more third parties, and/or the like.

As used herein, it is understood that the terms “program code” and “computer program code” are synonymous and mean any expression, in any language, code or notation, of a set of instructions that cause a computing device having an information processing capability to perform a particular function either directly or after any combination of the following: (a) conversion to another language, code or notation; (b) reproduction in a different material form; and/or (c) decompression. To this extent, program code can be embodied as one or more types of program products, such as an application/software program, component software/a library of functions, an operating system, a basic I/O system/driver for a particular computing and/or I/O device, and the like. Further, it is understood that the terms “component” and “system” are synonymous as used herein and represent any combination of hardware and/or software capable of performing some function(s).

The foregoing description of various aspects of the disclosure has been presented for purposes of illustration and description. It is not intended to be exhaustive or to limit the disclosure to the precise form disclosed, and obviously, many modifications and variations are possible. Such modifications and variations that may be apparent to a person skilled in the art are intended to be included within the scope of the disclosure as defined by the accompanying claims.

What is claimed is:

1. A method of identifying patterns in a semiconductor layout, the method comprising:
specifying a target region by indicating polygonal regions on a mask layer;
generating a target vector using a two dimensional (2D) low discrepancy sequence;
identifying layout regions in a design layout;
generating a feature vector for a layout region;
comparing a subset of sequence derived feature values in the target vector with sequence derived feature values in a search region feature vector as an initial filter;
determining that the layout region does not contain a match if a comparison of the subset of sequence derived feature values in the target vector with corresponding values in the search region feature vector falls below a threshold; and
outputting search results.

2. The method of claim 1, further comprising computing additional sequence derived feature values to form a complete feature vector if the comparison of the subset of sequence derived feature values in the target vector with sequence derived feature values in the feature vector meets the threshold.

3. The method of claim 2, further comprising determining that the layout region forms a match if a comparison of the target vector with the complete feature vector meets a further threshold.

4. The method of claim 1, wherein the target vector and feature vector are determined by computing distances from points on a polygonal region to a sequence points generated from the 2D low discrepancy sequence.

5. A system for identifying patterns in a semiconductor layout, comprising:
a system for generating a target vector using a two dimensional (2D) low discrepancy sequence to select anchor points for measuring features in a design layout;
a system for identifying layout regions in the design layout;
a system for generating a feature vector for a layout region;
a system for comparing a subset of sequence derived feature values in the target vector with sequence derived values in a search region feature vector as an initial filter, wherein the system for comparing determines that the layout region does not contain a match if a comparison of the subset of sequence derived feature values in the target vector with sequence derived values in the feature vector falls below a threshold; and
a system for outputting search results.

6. The system of claim 5, wherein the system for generating the feature vector computes additional sequence values to form a complete feature vector if the comparison of the subset of feature derived sequence values in the target vector with feature derived sequence values in the feature vector meets the threshold.

7. The system of claim 6, wherein the system for comparing determines that the layout region forms a match if a comparison of the target vector with the complete feature vector meets a further threshold.

8. The system of claim 5, wherein the target vector and feature vector are determined by computing distances from points on a polygonal region to sequence points generated from the 2D low discrepancy sequence.

9. A computer program product stored on a computer readable medium for identifying patterns in a semiconductor layout, which when executed causes a computer system to perform functions comprising:
generating a target vector using a two dimensional (2D) low discrepancy sequence;
identifying layout regions in a design layout;
generating a feature vector for a layout region;
comparing a subset of sequence derived feature values in the target vector with sequence derived feature values in a search region vector as an initial filter, wherein the comparing determines that the layout region does not contain a match if a comparison of the subset of sequence derived feature values in the target vector with corresponding sequence derived feature values in the search region vector falls below a threshold; and
outputting search results.

10. The computer program product of claim 9, wherein generating the feature vector computes additional sequence values to form a complete feature vector if the comparing of the subset of feature derived sequence values in the target vector with feature derived sequence values in the feature vector meets the threshold.

11. The computer program product of claim 10, wherein the comparing determines that the layout region forms a match if a comparison of the target vector with the complete feature vector meets a further threshold.

12. The computer program product of claim 9, wherein the target vector and feature vector are determined by computing distances from points on a polygonal region to sequence points generated from the 2D low discrepancy sequence.
